(19) United States
(12) Patent Application Publication
(10) Pub. No.: US 2009/0073971 A1
(43) Pub. Date: Mar. 19, 2009

(54) PER-PACKET QUALITY OF SERVICE SUPPORT FOR ENCRYPTED IPSEC TUNNELS

(76) Inventor: POUYA TAAGHOL, San Jose, CA (US)

Correspondence Address: CARRIE A. BOONE, P.C., 2450 Louisiana, Suite # 400-711, HOUSTON, TX, 77006, US

(21) Appl. No.: 11/857,443

(22) Filed: Sep. 19, 2007

(51) Int. Cl. H04L 12/56

(52) U.S. Cl. 370/389

(57) ABSTRACT

A method for performing an IPSec tunneling operation is disclosed, which enables the ToS parameter of the QoS parameter in an inner packet to be copied to an outer packet before transmission across an un-trusted network. The QoS parameter is part of an IP header of the inner packet being transmitted. The copy of the ToS parameter is stored in the IP header of the outer packet. The ToS parameter may be stored in the outer packet IP header before or after ICV calculation under the AH protocol is performed.

### TECHNICAL FIELD

This application relates to IPSec tunneling and, more particularly, to ensuring Quality of Service capability with IPSec packets.

### BACKGROUND

Internet Protocol Security, or IPSec, is a security standard at the network or packet-processing layer, rather than at the application layer of network communication. Tunneling is the process of putting a packet inside another packet before transmission.

IPSec tunneling is widely used in the industry to encrypt data packets across un-trusted networks. The encryption of data packet usually entails encryption of the entire packet and wrapping the encrypted packet (inner packet) into another packet (outer packet) for routing over the un-trusted networks towards the destination point. The inner packet of IPSec is invisible to the transit networks.

FIG. 1 is a diagram depicting a network communication neighborhood 30, according to the prior art. The network communication neighborhood 30 includes an IPSec client termination point 20 and an IPSec network termination point 24, with an untrusted network or networks 22 disposed between therebetween. While an unsecure network connection 26 is shown between the network neighborhood entities, an IPSec tunnel 28 is used for secure communication between the IPSec client termination point 20 and the IPSec network termination point 24.

Quality of Service (QoS) is the idea that transmission rates, error rates, and other characteristics on a network may be measured, improved, and, to some extent, guaranteed in advance. In Internet Protocol (IP) networks, the QoS is enforced on IP packets based on the header of the IP packets. More specifically, a Type of Service (ToS) field in the IP header is used to apply the necessary priority and privileged treatment to the packet throughout the network.

A device at the client end may have several services running in parallel, which require a different QoS characteristic for each packet type. For example, the client may be sending both voice packets (i.e., real-time protocol, or RTP, packets) and hyper-text transport protocol (HTTP) traffic simultaneously. The end device applications indicted their desired QoS to the IP layer, which, in turn, constructs the ToS field in the packet header based on the requested priority by the application.

FIG. 2 is a diagram showing a prior art IPSec tunneling operation, according to the prior art. An unencrypted data packet 40, including an IP header 42 with a QoS parameter ToS field 44, is included in an outer packet 50, which includes its own IP header 52 and IPSec header 54.

Under the current tunnel-mode IPSec specifications, the inner packet (where the application data and ToS field 44 resides) is encrypted using IPSec protocols, such as encapsulating security payload (ESP) or authentication header (AH). Hence, the ToS field 44, where the specific QoS is embedded in a ToS format, is encrypted as the inner packet 40. The transit networks would not be able to see the desired ToS field 44 of the inner packet 40. Thus, no QoS could be applied to the packet from the source (IPSec client termination point 20) to the destination (IPSec network termination point 24) of the IPSec tunnel 28 of the network communication neighborhood 30 (see FIG. 1).

Thus, there is a continuing need for a IPSec tunneling method to address the above-described shortcomings of the prior art.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a diagram of a network communications neighborhood, according to the prior art;

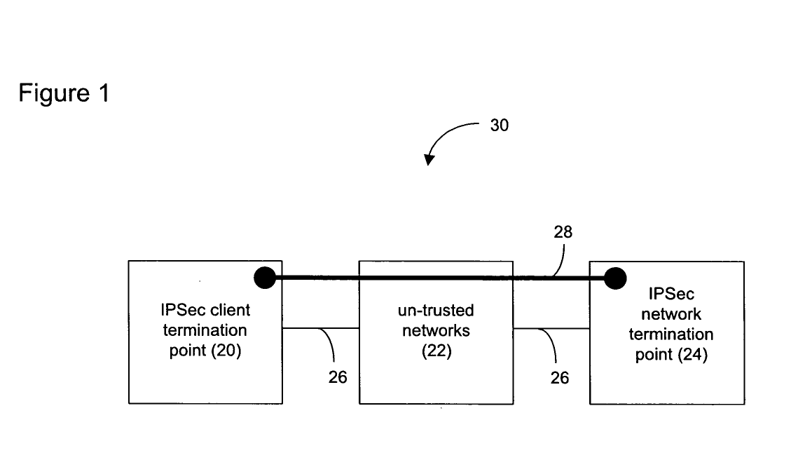

FIG. 2 is a diagram of an IPSec tunneling operation in which the Type of Service parameter is encrypted, according to the prior art;

FIG. 3 is a diagram depicting a Quality of Service (QoS) support method, according to some embodiments; and

FIG. 4 is a diagram of an IPSec client implementing the QoS support method of FIG. 3, according to some embodiments.

### DETAILED DESCRIPTION

In accordance with the embodiments described herein, a method for performing an IPSec tunneling operation is disclosed, which enables the Type of Service (ToS) parameter of the Quality of Service (QoS) parameter in an inner packet to be copied to an outer packet before transmission across an un-trusted network. The QoS parameter is part of an Internet protocol (IP) header of the inner packet being transmitted. The copy of the ToS parameter is stored in the IP header of the outer packet. The ToS parameter may be stored in the outer packet IP header before or after integrity check value (ICV) calculation under the authentication header (AH) protocol is performed.

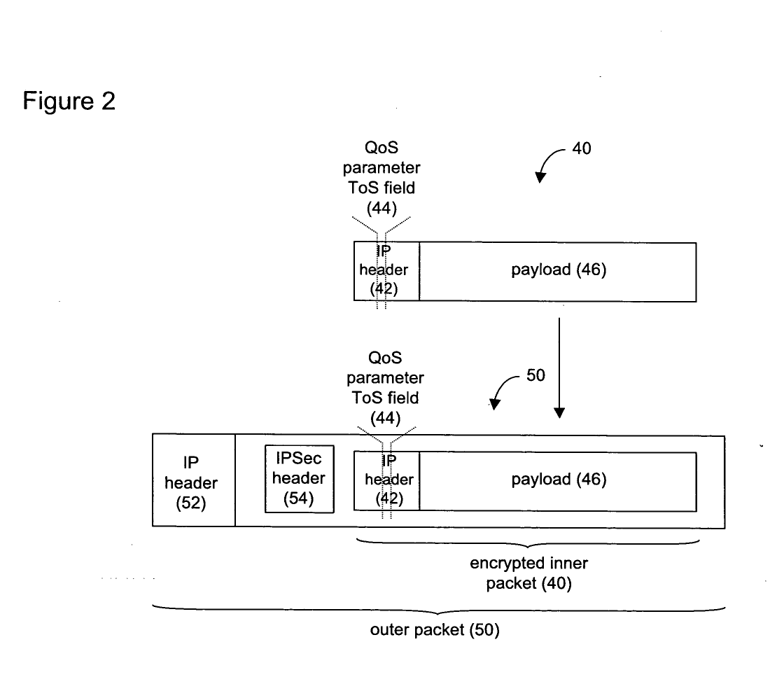

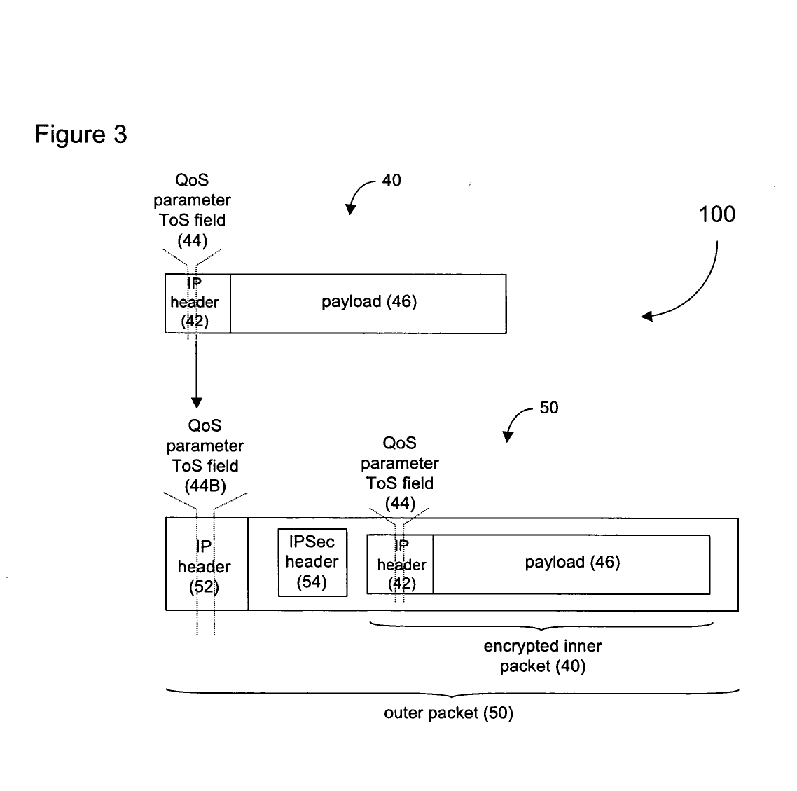

FIG. 3 is a diagram of a QoS support method 100, according to some embodiments. The unencrypted data packet 40, including an IP header 42 with a QoS parameter ToS field 44, is included in an outer packet 50, which includes its own IP header 52 and IPSec header 54, as in the prior art tunneling operation (see FIG. 2). However, this time, the ToS field 44 that is part of the QoS parameter in the IP header 42 of the encrypted inner packet 40 is copied, as QoS parameter ToS field 44B, and inserted into the IP header 52 of the outer packet 50. The ToS field 44B is thus available for QoS support while the encrypted inner packet 40 remains protected prior to transmission across the un-trusted networks 22 of the network communication neighborhood 30.

An authentication header (AH) protocol is used for authentication and data integrity checks in the IPSec suite. The AH process calculates an integrity check value (ICV). The ICV ensures that the packet 40 is not tampered with during transmission. The ICV calculation, however, does not involve the ToS field 44 of the inner packet 40. Hence, the QoS support method 100 may be performed prior to or following the AH ICV calculation.

The QoS support method 100 is advantageous because it enables QoS enforcement across networks for encrypted IPSec packets. Further the QoS support method 100 does not alter existing IPSec processes, such as the authentication header (AH) process. The QoS support method 100 is further advantageous by reducing unnecessary control signaling across the network for QoS support for IPSec, enabling use of existing QoS enforcements, such as differentiated services (DiffServ).

The QoS support method 100 may be included in third generation partnership project (3GPP) and Internet engineering task force (IETF) standard specifications. The QoS support method 100 is implemented as a software feature (embedded or not-embedded) on mobile devices such as application processors, as well as communication processors, or on other mobile platforms. The QoS support method 100 enables support for per-packet quality of service (QoS) despite the presence of encrypted IPSec tunnels.

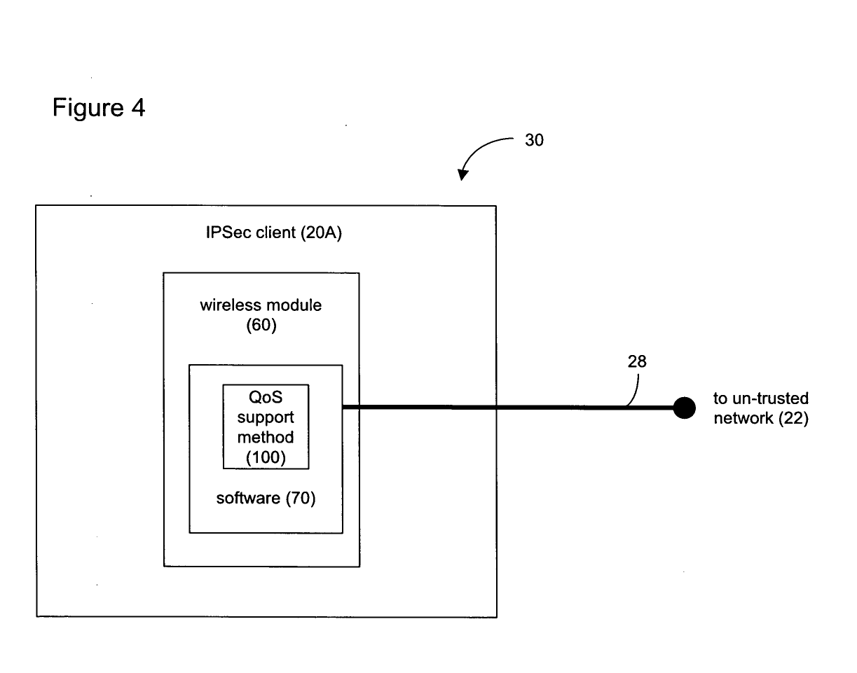

FIG. 4 is a diagram depicting one implementation of the QoS support method, according to some embodiments. The network communication neighborhood 30 includes an IPSec client 20A, for transmitting and receiving packets from other clients (not shown). The IPSec client 20A may be a wireless mobile device, such as a laptop computer, a handheld device, and so on. The packets are transmitted across the IPSec tunnel 28.

The IPSec client includes a wireless module 60, which may include software 70, in which the QoS support method 100 is executed. The software 70 may be a driver running inside the wireless module 60 or an operating system.

While the application has been described with respect to a limited number of embodiments, those skilled in the art will appreciate numerous modifications and variations therefrom. It is intended that the appended claims cover all such modifications and variations as fall within the true spirit and scope of the above description.

I claim:

1. A method, comprising:
copying a portion of a quality of service parameter from a first Internet protocol header of a first packet to be transmitted across a network, resulting in a second quality of service parameter;
storing the second quality of service parameter in a second Internet protocol header of a second packet;
wherein the first packet is stored in its entirety in the second packet before transmission across the network.

2. The method of claim 1, copying a quality of service parameter further comprising:
copying a type of service field that is part of the quality of service parameter.

3. The method of claim 1, further comprising:
calculating an integrity check value of the first packet, the integrity check value being part of an authentication header protocol of the first packet;
wherein the authentication header protocol is performed after the second quality of service parameter is stored in the second packet.

4. The method of claim 1, further comprising:
calculating an integrity check value of the first packet, the integrity check value being part of an authentication header protocol of the first packet;
wherein the authentication header protocol is performed before the second quality of service parameter is stored in the second packet.

5. An IPSec tunneling operation, comprising:
embedding an inner packet within an outer packet;
copying a portion of an inner packet header;
storing the copied portion in an outer packet header; and
transmitting the outer packet across a communications network.

6. The IPSec tunneling operation of claim 5, copying a portion of an inner packet header further comprising:
copying a quality of service parameter of the inner packet header.

7. The IPSec tunneling operation of claim 6, copying a quality of service parameter of the inner packet header further comprising:
copying a type of service field of the inner packet header;
wherein the type of service field is part of the quality of service parameter.

8. The IPSec tunneling operation of claim 5, storing the copied portion in an outer packet header further comprising:
executing an authentication header protocol on the inner packet;
wherein the authentication protocol is performed after the inner packet header portion is copied.

9. The IPSec tunneling operation of claim 5, storing the copied portion in an outer packet header further comprising:
executing an authentication header protocol on the inner packet;
wherein the authentication protocol is performed before the inner packet header portion is copied.

10. The IPSec tunneling operation of claim 8, executing an authentication header protocol on the inner packet further comprising:
calculating an integrity check value of the inner packet, the integrity check value being part of the authentication header protocol.

11. The IPSec tunneling operation of claim 9, executing an authentication header protocol on the inner packet further comprising:
calculating an integrity check value of the inner packet, the integrity check value being part of the authentication header protocol.

12. A client residing in a network communication neighborhood, the client comprising:
a wireless module for transmitting an IPSec packet across an IPSec tunnel, the IPSec tunnel to enter an un-trusted network, the wireless module to perform operations on the IPSec packet, the operations comprising:
making a copy of a type of service field from a header of the packet;
storing the copy in a second header, the second header being a part of an outer packet, wherein the outer packet encapsulates the packet.

13. The client of claim 12, wherein the operations are performed from within a driver running in the wireless module of the client.

14. The client of claim 12, wherein the operations are performed from within an operating system running in the wireless module of the client.

15. The client of claim 12, the operations further comprising:
calculating an integrity check value of the packet, the integrity check value being part of an authentication header protocol of the packet;
wherein the authentication header protocol is performed after the second type of service field is stored in the outer packet.

16. The client of claim 12, the operations further comprising:
calculating an integrity check value of the packet, the integrity check value being part of an authentication header protocol of the packet;
wherein the authentication header protocol is performed before the second type of service field is stored in the outer packet.
